(19) United States
(12) Patent Application Publication
(10) Pub. No.: US 2017/0021935 A1
(43) Pub. Date: Jan. 26, 2017

(54) Horizontal axis propeller engine assembly for an aircraft

(71) Applicant: Airbus Operations (SAS), Toulouse (FR)

(72) Inventor: Jacques Hervé Marche, Toulouse (FR)

(21) Appl. No.: 15/186,662

(22) Filed: Jun. 20, 2016

(30) Foreign Application Priority Data
Jul. 20, 2015 (FR) 1556839

(51) Int. Cl. B64D 27/26; B64F 5/00; B64D 35/00

(52) U.S. Cl. CPC B64D 27/26; B64D 35/00; B64F 5/0009; B64D 2027/266

(57) ABSTRACT

An engine assembly for an aircraft, comprising a mast. The engine assembly comprises an engine with a horizontal engine axis, an engine shaft having a first end rigidly connected to the engine and a second end, and a reducer having an input shaft meshing with the second end, and an output shaft to which a propeller is fixed. The engine assembly is configured such that the engine is fixed to the mast by a rigid connection, the reducer is fixed to the mast by means of flexible fasteners, the rotation between the engine shaft and the input shaft being driven via a slide link, the engine shaft has a first part and a second part and, therebetween, a flexible part assuring a tolerance to an angular misalignment between the axis of the second part and the axis of the first part.

### CROSS-REFERENCES TO RELATED APPLICATIONS

This application claims the benefit of the French patent application No. 1556839 filed on Jul. 20, 2015, the entire disclosures of which are incorporated herein by way of reference.

### BACKGROUND OF THE INVENTION

The present invention relates to a horizontal axis propeller engine assembly for an aircraft, the aircraft comprising at least one engine of this type, and also a method for installing an engine assembly of this type.

FIG. 1 shows a turboprop 10 of the prior art. The turboprop 10 comprises a turbine 12, a transmission shaft 14 driven in rotation about its axis by the turbine 12, a reducer 16, of which an input shaft is rigidly fixed to the transmission shaft 14, and a plurality of blades 18 fixed to an output shaft of the reducer 16 and forming a horizontal axis propeller.

This turboprop 10 is fixed beneath an aircraft mast by means of a plurality of flexible fasteners, each ensuring the filtration of vibrations generated by the propeller 18. These flexible fasteners generally number 3 or 4 at the front between the mast and the reducer 16, and generally number 2 at the rear between the mast and the turbine 12.

The turboprop 10 also has a torsion bar 20 between the reducer 16 and the turbine 12 in order to eliminate the torsion loads experienced by the flexible fasteners.

The assembly thus formed is hyperstatic, and it thus becomes difficult to determine the forces at the different interfaces because this is dependent on numerous variable parameters, such as the relative flexibility of the turbine, of the mast, and of the flexible fasteners, as well as manufacturing tolerances and differential thermal distortions.

Contrasting objectives thus conflict with one another because, for reasons of weight, it is preferable to design a lightweight and therefore flexible mast, whereas the transmission of the forces generated by the propeller through the mast, and not the turbine, requires the design of a rigid and therefore heavy mast.

### SUMMARY OF THE INVENTION

An object of the present invention is to provide a horizontal axis propeller engine assembly which makes it possible to obtain a more isostatic assembly enabling a simplified design.

For this purpose, what is proposed is an engine assembly for an aircraft comprising a mast, the engine assembly comprising:
an engine with a horizontal engine axis,
an engine shaft having a first end rigidly connected to the engine and a second end,
a reducer having an input shaft meshing with the second end, and an output shaft, and
a propeller fixed to the output shaft and rotatable about a horizontal propeller axis,

the engine assembly being characterized in that

the engine is fixed to the mast by a rigid connection,

the reducer is fixed to the mast by means of flexible fasteners,

the rotation between the engine shaft and the input shaft is driven via a slide link,

the engine shaft has a first part carrying the first end and having a secondary axis, and a second part carrying the second end and having, as its axis, the engine axis, and a flexible part, between the first part and the second part, ensuring a tolerance to an angular misalignment between the engine axis of the second part and the secondary axis of the first part.

An assembly of this type makes it possible to limit the hyperstatic state and makes it possible to disassemble independently, on the one hand, the reducer and the propeller, and, on the other hand, the engine.

The angular misalignment is advantageously 1° at most.

The reducer advantageously has a cylindrical casing, the engine has a cylindrical casing coaxial with the casing of the reducer, and the casing of the reducer fits with the casing of the engine so as to form a short centering.

The engine assembly advantageously comprises a take-up system transmitting the torque Mx from the propeller to the mast.

The take-up system advantageously comprises:
a torsion bar mounted on the reducer freely in rotation about its axis and having two ends,
for each end of the torsion bar, a lever arm, a first end of each lever arm being rigidly fixed to one of said ends of the torsion bar,
for each lever arm, a connecting rod, of which a first end is mounted freely in rotation on a second end of said lever arm,
for each connecting rod, a clevis fixed to the mast and in which a second end of said connecting rod is mounted freely in rotation.

The invention also proposes an aircraft comprising a mast and an engine assembly according to one of the preceding variants.

The invention also proposes a method for installing an engine assembly on an aircraft mast, the installation method comprising:
a first fixing step, during which the reducer is fixed on the mast by placing the flexible fasteners in position,
a fitting step, during which the engine and the engine shaft are placed in position by translation parallel to the engine axis and by fitting the second part in the input shaft, and
a second fixing step, during which the engine is fixed to the mast by the rigid connection.

### BRIEF DESCRIPTION OF THE DRAWINGS

The features of the invention mentioned above, as well as further features, will become clearer upon reading the following description of an exemplary embodiment, said description being provided with reference to the accompanying figures, in which:

FIG. 1 shows a side view of a turboprop of the prior art,

FIG. 2 shows a side view of an aircraft according to the invention,

FIG. 3 shows an exploded perspective view of an engine assembly according to the invention,

FIG. 4 shows a side view of the engine assembly of FIG. 3,

FIG. 5 shows a sectional side view of a detail of the engine assembly of FIG. 3, and

FIG. 6 shows a flow chart of a method for installing the engine assembly according to the invention on an aircraft.

### DETAILED DESCRIPTION OF THE PREFERRED EMBODIMENTS

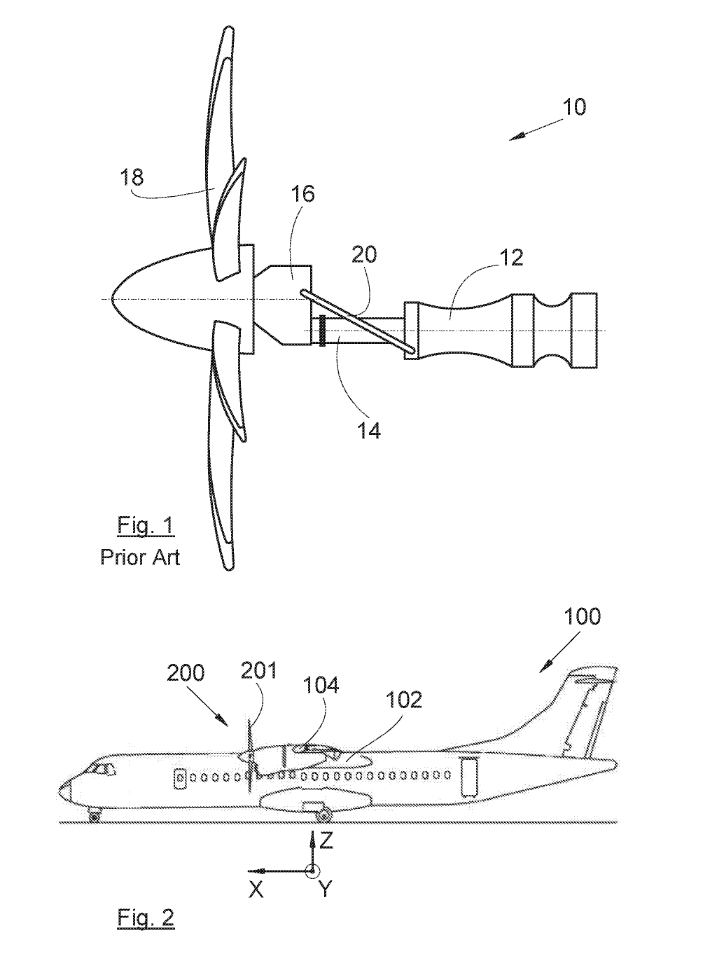

In the following description, the terms relating to a position are provided with reference to an aircraft in the normal position of use, i.e., as shown in FIG. 2.

FIG. 2 shows an aircraft 100 comprising two wings 102, below each of which there is fixed a mast 104, which supports an engine assembly 200 with a horizontal axis propeller 201.

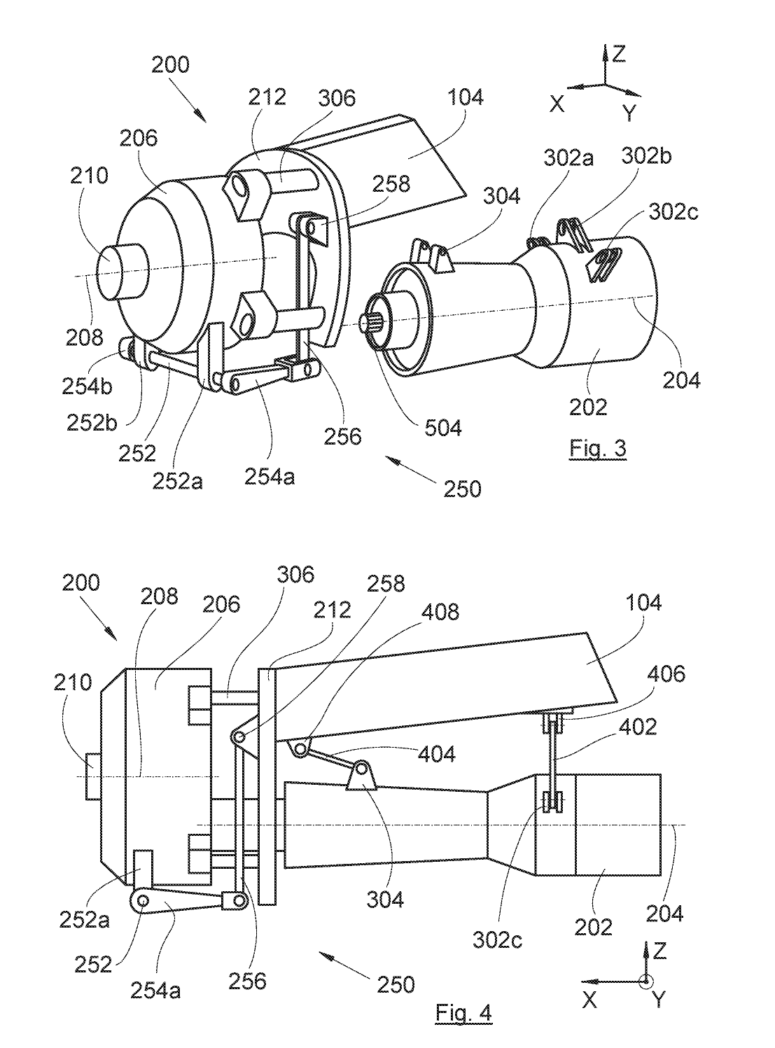

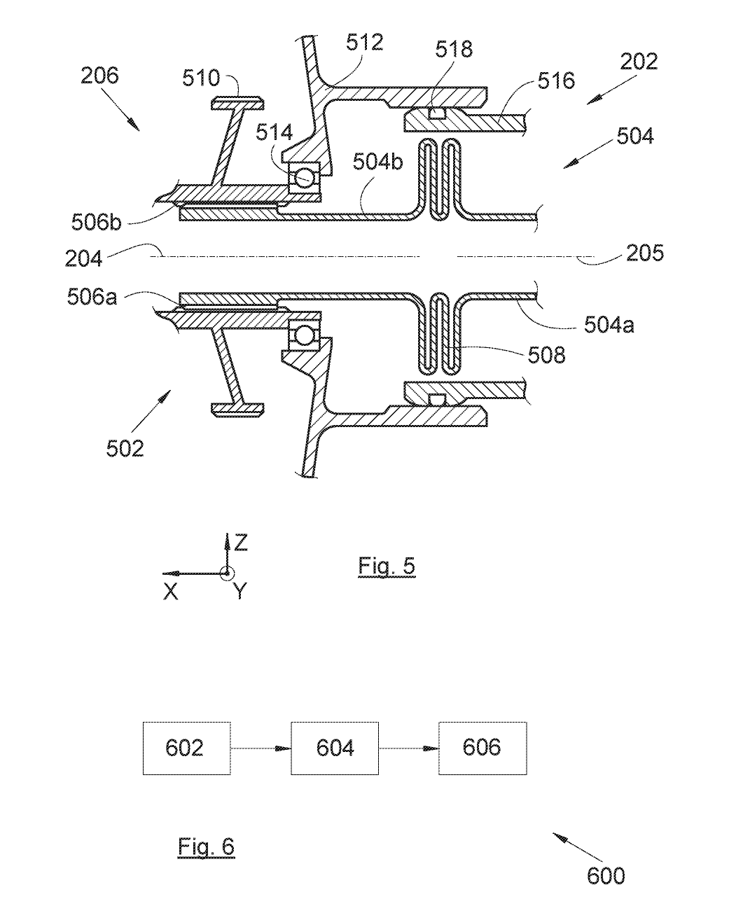

FIG. 3 and FIG. 4 show the engine assembly 200, which has an engine 202 with an engine axis 204, an engine shaft 504, of which a first end is rigidly fixed to the engine 202, and more particularly to the elements of the engine 202 that generate the rotation about the engine axis 204, a reducer 206 having an input shaft 502 (FIG. 5), which meshes with a second end of the engine shaft 504, and having an output shaft 210, and a propeller 201 fixed to the output shaft 210 and rotatable about a propeller axis 208.

The propeller axis 208 and the engine axis 204 are parallel to a longitudinal axis X of the aircraft 100, which is horizontal and oriented here positively in the direction of forward movement of the aircraft 100.

The transverse axis of the aircraft 100, which is horizontal when the aircraft 100 is on the ground, is denoted by Y, and Z is the vertical or vertical height axis when the aircraft 100 is on the ground, these three directions X, Y and Z being orthogonal to one another.

The engine 202 is fixed to the mast 104 by a rigid connection, here by means of rigid fixing elements such as connecting rods, for example. In the embodiment of the invention presented here, there are three connecting rods 402 at the rear and a central connecting rod 404 at the front.

Each connecting rod 402, 404 is fixed between a clevis of the mast 104 and a clevis of the engine 202. For each connecting rod 402 at the rear, the engine 202 thus has a clevis 302a-c of which the axis is parallel to the longitudinal axis X, and for the central connecting rod 404 the engine 202 has a central clevis 304 of which the axis is parallel to the transverse axis Y. The three connecting rods 402 at the rear make it possible to take up degrees of freedom Mx, Fy and Fz.

In the same way, the mast 104 has, for each connecting rod 402 at the rear, a clevis 406 of which the axis is parallel to the longitudinal axis X, and for the central connecting rod 404, the mast 104 has a clevis 408 of which the axis is parallel to the transverse axis Y. The central connecting rod 404 will take up a residual thrust Fx of the engine 202.

The reducer 206 is fixed to a frame 212 of the mast 104 by means of flexible fasteners 306, here numbering four. The flexible fasteners 306 are of the silentbloc® type, for example. The four flexible fasteners 306 take up 12 degrees of freedom and the thrust Fx, the inertial forces Fy and Fz, and the transverse torques My and Mz. In the embodiment of the invention shown here, the four flexible fasteners 306 are distributed symmetrically in the four quadrants defined by the planes XZ and XY. Each flexible fastener 306 is rigidly fixed to the reducer 206 and to the frame 212.

FIG. 5 shows the mechanical connection between the second end of the engine shaft 504 and the input shaft 502 of the reducer 206.

The rotation between the engine shaft 504 and the input shaft 502 of the reducer 206 is driven via a slide link parallel to the engine axis 204 and formed for example with the aid of grooves parallel to the engine axis 204. In the embodiment of the invention shown in FIG. 5, the second end of the engine shaft 504 has outer splines 506a and the input shaft 502 has inner splines 506b, which mesh with the outer splines 506a.

This assembly by slide link makes it possible to assure a freedom of movement, along the longitudinal axis X, of the reducer 206 and of the engine shaft 504, thus limiting the hyperstatic state.

The engine shaft 504 has a first part 504a carrying the first end, and a second part 504b carrying the second end. Between the first part 504a and the second part 504b, the engine shaft 504 has a flexible part 508. The second part 504b has, for its axis, the engine axis 204, and the first part 504a has, for its axis, a secondary axis 205, which is normally coaxial with the engine axis 204. The flexible part 508 assures a tolerance to an angular misalignment between the engine axis 204 of the second part 504b and the secondary axis 205 of the first part 504a. The angular misalignment is 1° at most.

The flexible part 508 is formed, for example, with the aid of a coupling (semi-rigid cardan coupling). The flexible part 508 makes it possible to compensate for errors of parallelism between the input shaft 502 and the engine shaft 504.

An assembly of this type makes it possible to minimize the hyperstatic state. In addition, the reducer 206 provided with the propeller 201 can be easily separated from the engine shaft 504, since it is attached to the mast 104 independently of the fixing of the engine 202, thus facilitating the maintenance of the aircraft 100.

Here, the input shaft 502 carries a pinion 510, which forms part of the gear train assuring the reduction.

The reducer 206 has a cylindrical casing 512, which is mounted on the input shaft 502 by means of a ball bearing 514 having, as its axis, the engine axis 204. The engine 202 also has a cylindrical casing 516 also having, as its axis, the engine axis 204. The casing 512 of the reducer 206 fits on the exterior of the casing 516 of the engine 202 so as to form a short centering, which makes it possible to eliminate two degrees of freedom (the translations along the axes Y and Z), and which is defined by the ratio L/D<0.8, where L is the length of contact between the two casings 512 and 516, and where D is the diameter. The short centering allows an angular displacement as well as an axial sliding. The two degrees of freedom Fz and Fy of the engine 202 are thus transmitted via the short centering to the mast 104.

It is also possible for the short centering to be provided by fitting the casing 512 of the reducer 206 inside the casing 516 of the engine 202.

In order to assure the tightness, a seal 518, for example of the O-ring seal type, is placed in a groove in the casing 516 of the engine 202 between the two casings 512 and 516.

The engine assembly 200 also has a take-up system 250, which makes it possible to transmit the torque Mx from the propeller to the mast 104, and more particularly to the frame 212. The take-up system can be based on a hydraulic system.

In the embodiment of the invention shown in FIGS. 3 and 4, the take-up system 250 comprises:
a torsion bar 252 mounted on the reducer 206 freely in rotation about its axis parallel to the transverse axis Y and having two ends,
for each end of the torsion bar 252, a lever arm 254a-b, of which a first end is rigidly fixed to each end of the torsion bar,
for each lever arm 254a-b, a connecting rod 256 (only one of which is visible in the drawings), of which a first end is mounted freely in rotation on a second end of said lever arm 254a-b about an axis parallel to the transverse axis Y,
for each connecting rod 256, a clevis 258 fixed to the frame 212 of the mast 104 and in which a second end of said connecting rod 256 is mounted freely in rotation about an axis parallel to the transverse axis Y.

Here, the torsion bar 252 is fixed to the reducer 206 by two bearings 252a-b connected to the reducer 206.

Each lever arm 254a-b has an orientation substantially parallel to the longitudinal axis X.

Each connecting rod 256 has an orientation substantially parallel to the vertical axis Z.

FIG. 6 shows a flow chart of a method 600 for installing the engine assembly 200 on the mast 104 of the aircraft 100. The installation method 600 comprises:
a first fixing step 602, during which the reducer 206 is fixed to the frame 212 of the mast 104 by placing the flexible fasteners 306 and the take-up system 250 in position,
a fitting step 604, during which the engine 202 and the engine shaft 504 are placed in position by translation parallel to the engine axis 204 and by fitting the second part 504a in the input shaft 502, and by fitting the casing 512 of the reducer 206 with the casing 516 of the engine 202, and
a second fixing step 606, during which the engine 202 is fixed to the mast 104 by the rigid connection.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An engine assembly for an aircraft, comprising a mast, the engine assembly comprising:
an engine with a horizontal engine axis,
an engine shaft having a first end rigidly connected to the engine and a second end,
a reducer having an input shaft meshing with the second end of the engine shaft, and an output shaft, and
a propeller fixed to the output shaft and rotatable about a horizontal propeller axis,
wherein, in the engine assembly,
the engine is fixed to the mast by a rigid connection,
the reducer is fixed to the mast by means of flexible fasteners,
the rotation between the engine shaft and the input shaft is driven via a slide link,
the engine shaft has a first part carrying the first end and having a secondary axis, and a second part carrying the second end and having, as its axis, the engine axis, and a flexible part, between the first part and the second part, assuring a tolerance to an angular misalignment between the engine axis of the second part and the secondary axis of the first part.

2. The engine assembly as claimed in claim 1, wherein the angular misalignment is at most 1°.

3. The engine assembly as claimed in claim 1, wherein the reducer has a cylindrical casing, and wherein the engine has a cylindrical casing coaxial with the casing of the reducer, and wherein the casing of the reducer fits with the casing of the engine so as to form a short centering.

4. The engine assembly as claimed in claim 1, further comprising a take-up system transmitting the torque Mx from the propeller to the mast.

5. The engine assembly as claimed in claim 4, wherein the take-up system comprises:
a torsion bar mounted on the reducer freely in rotation about an axis of the torsion bar and having two ends,
a lever arm for each end of the torsion bar, a first end of each lever arm being rigidly fixed to one of said ends of the torsion bar,
for each lever arm, a connecting rod, of which a first end is mounted freely in rotation on a second end of said lever arm,
for each connecting rod, a clevis fixed to the mast and in which a second end of said connecting rod is mounted freely in rotation.

6. An aircraft comprising:
a mast and
an engine assembly, the engine assembly comprising:
an engine with a horizontal engine axis,
an engine shaft having a first end rigidly connected to the engine and a second end,
a reducer having an input shaft meshing with the second end of the engine shaft, and an output shaft, and
a propeller fixed to the output shaft and rotatable about a horizontal propeller axis,
wherein, in the engine assembly,
the engine is fixed to the mast by a rigid connection,
the reducer is fixed to the mast by means of flexible fasteners,
the rotation between the engine shaft and the input shaft is driven via a slide link,
the engine shaft has a first part carrying the first end and having a secondary axis, and a second part carrying the second end and having, as its axis, the engine axis, and a flexible part, between the first part and the second part, assuring a tolerance to an angular misalignment between the engine axis of the second part and the secondary axis of the first part.

7. A method for installing an engine assembly on a mast of an aircraft, the engine assembly comprising:
an engine with a horizontal engine axis,
an engine shaft having a first end rigidly connected to the engine and a second end,
a reducer having an input shaft meshing with the second end of the engine shaft, and an output shaft, and
a propeller fixed to the output shaft and rotatable about a horizontal propeller axis,
wherein, in the engine assembly,
the engine is fixed to the mast by a rigid connection,
the reducer is fixed to the mast by means of flexible fasteners,
the rotation between the engine shaft and the input shaft is driven via a slide link,
the engine shaft has a first part carrying the first end and having a secondary axis, and a second part carrying the second end and having, as its axis, the engine axis, and a flexible part, between the first part and the second part, assuring a tolerance to an angular misalignment between the engine axis of the second part and the secondary axis of the first part,
the installation method comprising:
in a first fixing step, fixing the reducer to the mast by placing the flexible fasteners in position,
in a fitting step, placing the engine and the engine shaft in position by translation parallel to the engine axis and fitting the second part in the input shaft, and
in a second fixing step, fixing the engine to the mast by the rigid connection.
